(19) United States
(12) Patent Application Publication
(10) Pub. No.: US 2014/0223100 A1
(43) Pub. Date: Aug. 7, 2014

(54) RANGE BASED COLLECTION CACHE

(71) Applicant: Alex J. Chen, Fremont, CA (US)

(72) Inventor: Alex J. Chen, Fremont, CA (US)

(21) Appl. No.: 13/762,028

(22) Filed: Feb. 7, 2013

(51) Int. Cl. G06F 12/08

(52) U.S. Cl. CPC G06F 12/0802
USPC 711/118

(57) ABSTRACT

A system enables older cached data to be kept against the same key while adding in new sets of data in the cache that have the affected dimensional changes. Set membership functions such as intersection and difference may be used on each dimension of the data to derive the correct range for which partition the data must belong to. Each range-based, partitioned set in the cache that is against the same key is mutually exclusive with another range-based, partitioned set for the same key. With ranged-based, partitioned set, a key can be queried to find out which sets are already stored and which sets may need to be stored. This approach allows the caching to be served longer when there are queries that are only interested in subsets of the data.

### BACKGROUND

Businesses must fetch and process large amounts of data to make strategic decisions and be successful. Caching is used to by computing systems to improve performance in fetching data by storing the data that is associated with a key in memory. When data is derived from multiple dimensions such as time component (like date ranges), names of something, and so forth, only the partial data may get changed as the dimension changes in size. Because of this, the cache gets cleared and new data with new dimensions are stored again. This rewrite of data costs caching performance due to re-serialization of the same data. What is needed is an improved method for handling cached data.

### SUMMARY

The present technology allows old data in a cache to be kept against the same key while adding in new sets of data that have the affected dimensional changes. Embodiments of the present invention may use one or more set membership functions--intersection and difference--on each dimension of the data to derive the correct range for which partition the data must belong to. Each range-based, partitioned set in the cache that is against the same key may be mutually exclusive with another range-based, partitioned set for the same key. With ranged-based, partitioned sets, a key can be queried to find out which sets are already stored and which sets may need to be stored. This allows the caching to be served longer when there are queries that are only interested in subsets of the data.

In an embodiment, a method for caching data may include caching a first received request for data by a cache such that the first request including a key and a range. A second request for data may be received by the cache, wherein the second request including a second key and a second range. The second request may be compared with the first request by the cache, and comparison data based on the compare may be provided in response to the second request received by the cache.

In an embodiment, a system for collecting data may include a memory, a processor and one or more modules stored in memory and executable by the processor. The modules may be executable cache a first received request for data by a cache such that the first request including a key and a range, receive second request for data by the cache, comparing the second request with the first request by the cache, and comparison data based on the compare may be provided in response to the second request received by the cache..

### BRIEF DESCRIPTION OF DRAWINGS

FIG. 1 is a block diagram of an exemplary system utilizing that utilizes a cache.

FIG. 2 is a block diagram of a mapping of a key to data objects.

FIG. 3 is a block diagram of range based collection cache components.

FIG. 4 is an exemplary method for caching data.

FIG. 5 is an exemplary method for providing cardinality sets.

FIG. 6 is a block diagram of a device for implementing the present technology.

### DETAILED DESCRIPTION

The present technology allows old data in a cache to be kept against the same key while adding in new sets of data that have the affected dimensional changes. Embodiments of the present invention may use one or more set membership functions--intersection and difference--on each dimension of the data to derive the correct range for which partition the data must belong to. Each range-based, partitioned set in the cache that is against the same key may be mutually exclusive with another range-based, partitioned set for the same key. With ranged-based, partitioned sets, a key can be queried to find out which sets are already stored and which sets may need to be stored. This allows the caching to be served longer when there are queries that are only interested in subsets of the data.

Embodiments of the present invention include a range-based collection cache that offers some functionality of set memberships in addition to a traditional cache. A ranged-based collection is an ordered set that consists of a time series and/or a non-time series. A time series set is a set of elements that are ordered in chronological order. A non-time series set is a set of elements that are ordered in lexical order. Though both types of sets are range based, their elements may not necessary be in contiguous sequence, because gaps are allowed. The present range based collection (RBC) cache can be queried to obtain a response that a complete data set exists to satisfy the query or a partial data set exists and provides the missing range(s) and their cardinalities.

Additional functionalities of RBC cache are family sets and dirty cache detection. A family of sets is a collection of sets that are range-indexed to provide pagination capability. The pagination is arranged (sorted) and grouped by the client, because the RBC Cache is oblivious to any client's data-specific objects. Dirty cache detection is to provide purging of stale cache data by letting the client repopulate them.

The RBC cache may store new data objects whose range information is not in conflict with the range information of any existing data objects. A conflict is defined as having an overlap (or intersection) of any kind of range types for which the overlap is not a superset. Therefore, RBC cache ache only contains a collection of disjoint data objects with their disjoint range information. Whenever a new data object has range information that is a superset of the range information of the existing data objects, the new data object may replace all those existing data objects.

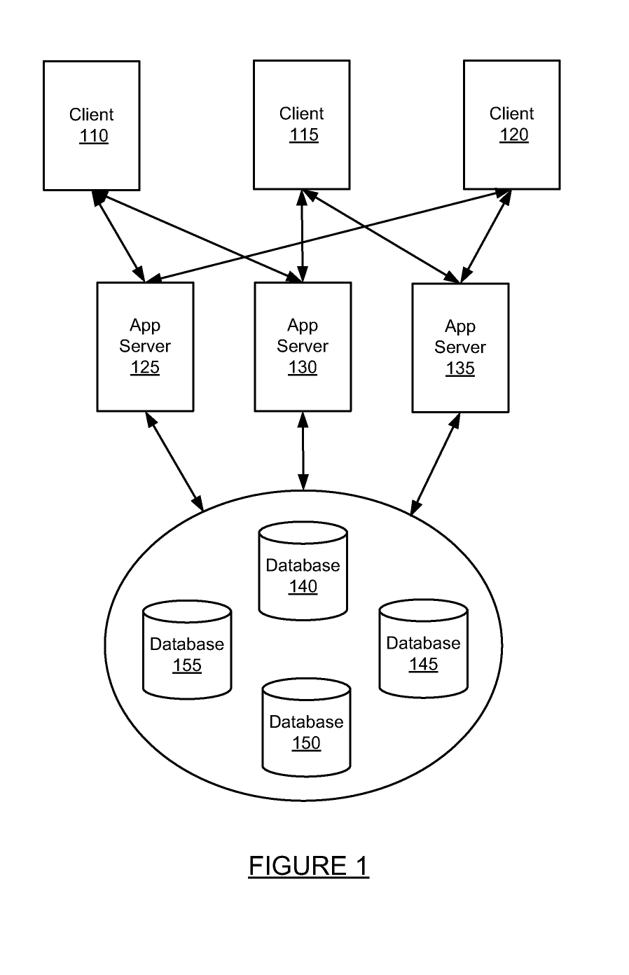

FIG. 1 is a block diagram of an exemplary system utilizing that utilizes a cache. The system of FIG. 1 includes clients 110, 115 and 120, application servers 125, 130 and 135, and databases 140, 145, 150 and 155. In a typical system, several clients may send requests (e.g., queries) to an application server. For example, application server 125 may receive requests from clients 110 and 120 while application server 130 may receive requests from clients 110 and 114. Application servers 125-135 process requests by retrieving data from one or more of databases 140-155. Each application server may maintain a cache of recently collected data. Embodiments of the present invention may implement a range based collection (RPC) cache, or “fuzz cache”, at one or more application servers. The RPC cache or fuzzy cache allows old data in a cache to be kept against the same key while adding in new sets of data that have the affected dimensional changes.

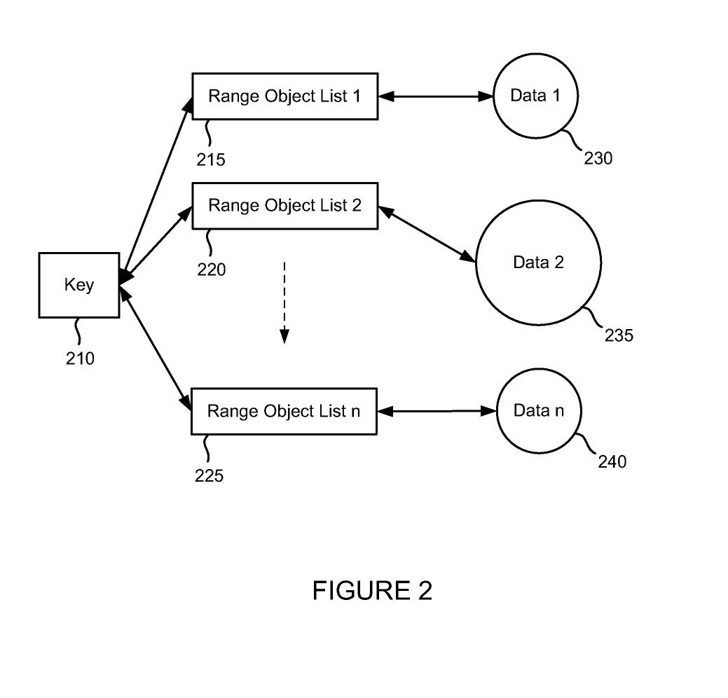

FIG. 2 is a block diagram of a mapping of a key to data objects. A key may pertain to one more range object lists, while each range object list may pertain to a data object. In FIG. 2, key 210 is mapped to range object list 1 (215), range object list 2 (220), all the way through range object list n (225). Each of range object lists 1, 2 and n are mapped to data objects 230, 235 and 240.

A range object list may include a list of data descriptors, such as years, months, employee last names, and so forth. The lists may be a time series ordered set which may be ordered in chronological order or a non-time series that may be ordered in lexical order. The data objects may include data that satisfy the particular object list. The key may be a unique identifier used to identify the particular data set. A key may be generated from information such as tenant identification, role identification, KPI identification, and table name lists.

The generation of the query key may exclude all the range information's specific value in that the key should not have any values specific to the range types (e.g., ‘July’ for month or ‘Math’ for department). One query that contains a group-by clause will have a different query key from another query that has no group-by clause. A query to the RBC cache may not have to include all the range information. This is to allow a wildcard on a non-specified range type. For instance, a query with just department range object only and not a month range object means the result set can be derivative of any months. This approach simplifies the client's use of RBC cache.

The key-to-range object mapping may be maintained in two ways: a) in a linked list and b) in a hash table. From a hash table, the data object can be retrieved efficiently for the API data fetch call. From a linked list, a walk-through of each range object may be carried out for the API data membership check call. The mapping and its metadata along with the key and data objects are also stored using the underlying open source cache/NoSQL DB. All the range objects per key belong to a disjoint set of range information. All range objects may be immutable objects as well as data objects. When the key is inserted for the first time, it defines the definition of the ranged-based collection for future inserts and updates on subsequent data objects. The range information defined by the first key is seen for the first time; thus, it will be used to carry out future ranged-based comparisons and calculations.

Though RBC cache does not care about the structure and contents of data objects, the client must ensure that all data objects stored against the same key have consistent structure and content types. One data object can have a time-based range object to represent months but stores data objects with daily records with their monthly aggregations. Subsequent data objects in different time-based range information that are stored against the same key should also have the same structure and contents—i.e., daily records with monthly aggregations. However, another client that is only interested in daily records may want to use the other client's data objects stored by generating the same key to request for data set.

For performance optimization, each range object in range information list may have a hash code to identify its range object type. The hash code does not have to be globally unique (which is impossible), but it allows RBC cache to verify if the inputted range information against the same key could be valid or not before performing any range comparisons and calculations.

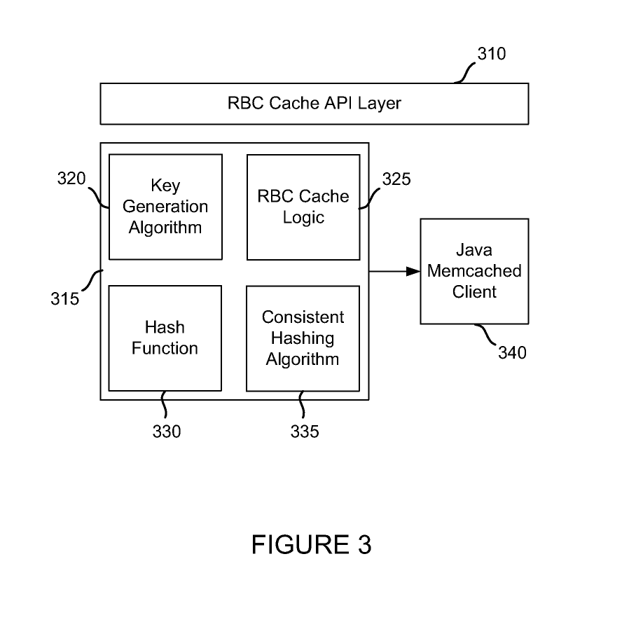

FIG. 3 is a block diagram of range based collection cache components. The cache components include a cache API layer 310, key generation algorithm 320, cache logic 325, hash function 330, consistent hashing algorithm 335, and ordinary cache 340. Key generation algorithm 320 is implemented to ensure consistent creation of keys when using certain types of queries, such as for example SQL-based queries. Hash function 330 and consistent hashing algorithm 335 operate to perform and manage hash functions. Fuzzy Cache logic provides the range-based collection algorithm and may be implemented on top of a Memcached client. An example of a memcached client is the open source Java Memcached Client. Java Memcached Client has shown good stable benchmarks for large number of threads for multi-get and multi-set with high transaction throughputs where the logic of Fuzzy Cache requires in its metadata mapping to data objects.

In some embodiments, the RBC cache will use consistent hashing algorithms. This kind of algorithm is to prevent sudden large cache misses for existing cached objects when a cache server has failed or removed, because “hash(o) mod n” will yield a different bucket due to a different value of n. A consistent hashing algorithm employs the concept of a ring with node value ranges around the ring to accept “hash(o)” being mapped to the same value range of a node.

An example of a suitable hashing function is the Murmur Hash function. Empirically, this hash function has more stability in output bit changes per input bit changes for an input value, a problem known as an avalanche effect. The high variability in output bit changes (avalanche effect) causes a higher chance of hash collisions. Avalanche effect is desirable in cryptography but not in hashing functions.

An API pass-through from the Fuzzy Cache to a traditional cache is used to allow traditional non-fuzzy cache usage. However, the pass-through still uses hash function and consistent hashing algorithm. Fuzzy Cache implementation may be provided as a Java API and may be packaged as a JAR file. Fuzzy Cache will try to leverage the performance and optimizations of the Memcached client like using binary protocol and multi-get function.

In the logical model, the cache of the present invention may stores the key and its range information list as an object in a memcached server. Because one key means a collection of data objects, the metadata encapsulates range information lists that map to the data objects in the collection. By storing each data object separately in a memcached server, the present cache can overcome the 1 MB limit on object size by memcached server and provide independent fetch of data objects based on range information.

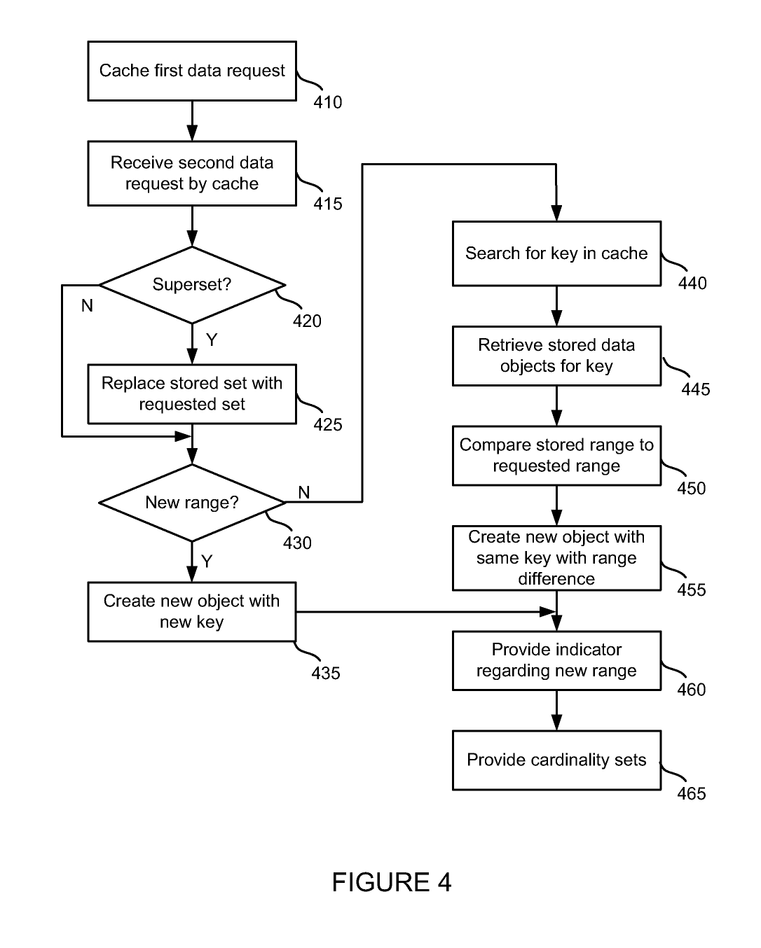

FIG. 4 is an exemplary method for caching data. First, a first data request is cached at step 410. The first data request may be received by the RCB cache and associated with a key and a list of range metadata objects. The data corresponding to the request is also stored with the cache. A second data request is received by the cache at step 415. The second data request may also include a key and a list of range metadata objects. A determination is made as to whether the received list of range metadata objects in the second request is s superset of the stored list of range metadata objects in the first request. If the list of range metadata objects for the stored request is contained within the list of range metadata objects of the second received request, then the stored set is replaced with the requested sets at step 425 and the method continues to step 430. If the received request is not a superset of the stored request, the method continues to step 430.

A determination is made as to whether the second request includes a new range with respect to the cached list of range metadata objects at step 430. If the second request requires a new range, such as a range that was not included in the stored list of range metadata objects, a new object with a new key is created at step 435 and the method continues to step 460. If a new range is not required, the cache is searched for the key mentioned in the second request at step 440. If the key is not found (not shown in FIG. 4), a new object is created at step 435. If the key is found, the stored data objects for the key are retrieved at step 445.

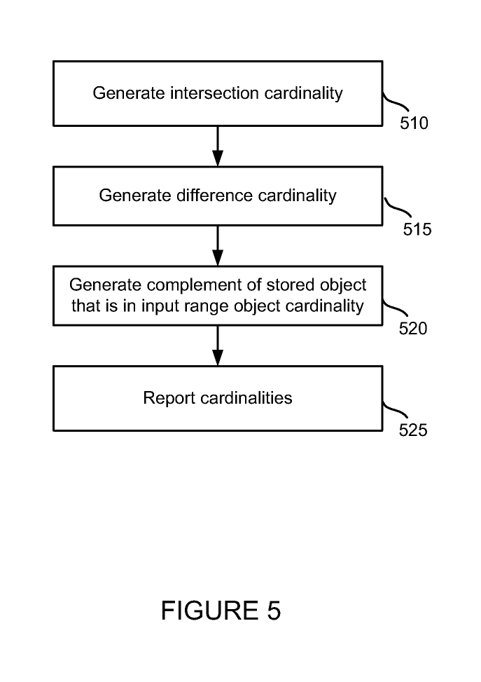

The stored range objects are compared to the requested range objects at step 450. A new data object with the same key may and different range object may be created at step 455. The new data object with different range objects may be created if the range objects between the two requests differ. After creating a new object, an indicator regarding a new range is provided at step 460. The indicator may indicate whether a new range was created by the cache in response to the request. Cardinality sets (e.g., comparison data) are provided based on the comparison at step 465. The comparison data forming the cardinality sets may include one or more sets that indicate how the stored range object and received range object compare. Providing cardinality sets is discussed with respect to FIG. 5.

As an example, a query may be generated to select all students from the Math and the English departments whose birthdays are in the summer. For this query, the three components for the call to RBC cache to store the result set will be a key, a data set, and range information. A second query may be generated to find all students from those two same departments but whose birthdays lie in summer and winter months. The request includes components of key and range information. The same key is used as the first query because we're interested in the same kind of result set though in a larger range search. The range information contains time-based range information that represents the months of July, August, September, December, January, and February. Because RBC cache has Key1 in its cache, it reads out RangeInfo1 object and compares with RangeInfo2 object. The result of the comparison returns a new range information object that contains only the winter months, namely, ‘December’, ‘January’, and ‘February’. With the new range information, the second query can be modified to select only those months.

If there is another (third) query that asks for the Physics and the Biology departments that have students in both summer and winter months, the query will have a different key, because the first query only has one range object type (birthday months) instead of also including departments. So the cached object for the first query would not satisfy this query. The RBC cache will always return two pieces of information: (1) For each inputted range object, whether there is a new range object for that range object, and (2) for each new range object, the cardinalities of the range in different “view sets”.

FIG. 5 is an exemplary method for providing cardinality sets. An intersection cardinality may be generated at step 510. For example, for a stored set having range objects of March, April, and May, and received set having range objects of May, June, July, the intersection cardinality would be one—for May. The difference cardinality is generated at step 515. In the current example, the difference cardinality would be two—corresponding to June and July. The complement cadinality of the stored object that is in input range object is determined at step 520. The complement cardinality of the example would be two—for June and July. The cardinalities are reported to the requesting entity at step 525.

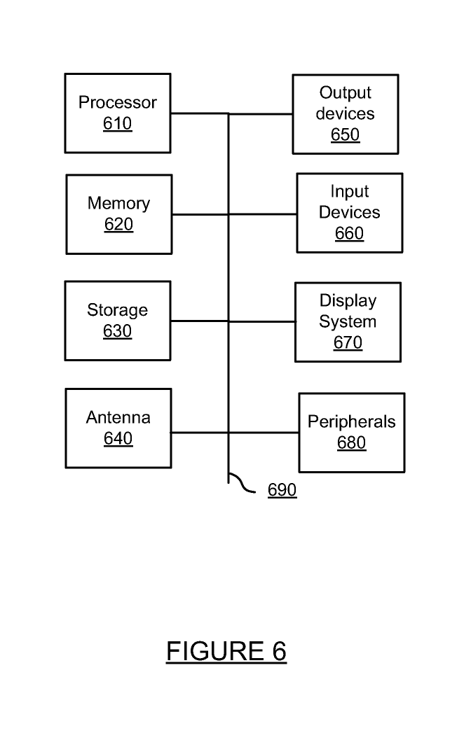

FIG. 6 is a block diagram of a device for implementing the present technology. FIG. 6 illustrates an exemplary computing system 600 that may be used to implement a computing device for use with the present technology. System 600 of FIG. 6 may be implemented in the contexts of the likes of application servers 125-135. The computing system 600 of FIG. 6 includes one or more processors 610 and memory 620. Main memory 620 may store, in part, instructions and data for execution by processor 610. Main memory can store the executable code when in operation. The system 600 of FIG. 6 further includes a storage 620, which may include mass storage and portable storage, antenna 640, output devices 650, user input devices 660, a display system 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the storage 630, peripheral device(s) 680 and display system 670 may be connected via one or more input/output (I/O) buses.

Storage device 630, which may include mass storage implemented with a magnetic disk drive or an optical disk drive, may be a non-volatile storage device for storing data and instructions for use by processor unit 610. Storage device 630 can store the system software for implementing embodiments of the present invention for purposes of loading that software into main memory 610.

Portable storage device of storage 630 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device.

Antenna 640 may include one or more antennas for communicating wirelessly with another device. Antenna 616 may be used, for example, to communicate wirelessly via Wi-Fi, Bluetooth, with a cellular network, or with other wireless protocols and systems. The one or more antennas may be controlled by a processor 610, which may include a controller, to transmit and receive wireless signals. For example, processor 610 execute programs stored in memory 612 to control antenna 640 transmit a wireless signal to a cellular network and receive a wireless signal from a cellular network.

The system 600 as shown in FIG. 6 includes output devices 650 and input device 660. Examples of suitable output devices include speakers, printers, network interfaces, and monitors. Input devices 660 may include a touch screen, microphone, accelerometers, a camera, and other device. Input devices 660 may include an alpha-numeric keypad, such as a keyboard, for inputting alpha-numeric and other information, or a pointing device, such as a mouse, a trackball, stylus, or cursor direction keys.

Display system 670 may include a liquid crystal display (LCD), LED display, or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 500 of FIG. 5 are those typically found in computing system, such as but not limited to a desk top computer, lap top computer, notebook computer, net book computer, tablet computer, smart phone, personal data assistant (PDA), or other computer that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for caching data, comprising:
caching a first received request for data by a cache, the first request including a key and a range;
receiving a second request for data by the cache, the second request including a second key and a second range;
comparing the second request with the first request by the cache; and
providing comparison data based on the compare in response to the second request received by the cache.

2. The method of claim 1, wherein the first key and the second key have the same value.

3. The method of claim 1, wherein the comparison data includes an intersection of the first range and the second range.

4. The method of claim 1, wherein the comparison data includes the difference between the first range and the second range.

5. The method of claim 1, wherein the comparison data includes the complement of the first range that is present in the second range.

6. The method of claim 1, wherein the comparison data indicates the second range is a superset of the first range.

7. The method of claim 1, further comprising generating a new key in response to the second request.

8. A computer readable non-transitory storage medium having embodied thereon a program, the program being executable by a processor to perform a method for caching data, the method comprising:
caching a first received request for data by a cache, the first request including a key and a range;
receiving a second request for data by the cache, the second request including a second key and a second range;
comparing the second request with the first request by the cache; and
providing comparison data based on the compare in response to the second request received by the cache.

9. The computer readable non-transitory storage medium of claim 8, wherein the first key and the second key have the same value.

10. The computer readable non-transitory storage medium of claim 8, wherein the comparison data includes an intersection of the first range and the second range.

11. The computer readable non-transitory storage medium of claim 8, wherein the comparison data includes the difference between the first range and the second range.

12. The computer readable non-transitory storage medium of claim 8, wherein the comparison data includes the complement of the first range that is present in the second range.

13. The computer readable non-transitory storage medium of claim 8, wherein the comparison data indicates the second range is a superset of the first range.

14. The computer readable non-transitory storage medium of claim 8, further comprising generating a new key in response to the second request.

15. A system for caching data, comprising:
a memory;
a processor; and
one or more modules stored in memory and executable by the processor to:
cache a first received request for data by a cache, the first request including a key and a range;
receive a second request for data by the cache, the second request including a second key and a second range;
compare the second request with the first request by the cache; and
provide comparison data based on the compare in response to the second request received by the cache.

16. The system of claim 15, wherein the first key and the second key have the same value.

17. The system of claim 15, wherein the comparison data includes an intersection of the first range and the second range.

18. The system of claim 15, wherein the comparison data includes the difference between the first range and the second range.

19. The system of claim 15, wherein the comparison data includes the complement of the first range that is present in the second range.

20. The system of claim 15, wherein the comparison data indicates the second range is a superset of the first range.

21. The system of claim 15, further comprising generating a new key in response to the second request.
